(19) United States
(12) Patent Application Publication
(10) Pub. No.: US 2026/0287438 A1
(43) Pub. Date: Sep. 24, 2026

(54) INFRARED SENSING SYSTEM

(71) Applicant: KINPO ELECTRONICS, INC., New Taipei City (TW)

(72) Inventors: Wen-Jui LIU, New Taipei City (TW); Ming-Wei CHUANG, New Taipei City (TW)

(73) Assignee: KINPO ELECTRONICS, INC., New Taipei City (TW)

(21) Appl. No.: 19/205,197

(22) Filed: May 12, 2025

(30) Foreign Application Priority Data
Mar. 19, 2025 (TW) 114110244

(51) Int. Cl. G01J 5/34; G01J 5/00; G01J 5/0806

(52) U.S. Cl. CPC G01J 5/34; G01J 5/0025; G01J 5/0806

(57) ABSTRACT

An infrared sensing system includes: an infrared sensing element; an adjustment unit, disposed movably between a first position and a second position; a first lens, disposed between the infrared sensing element and the adjustment unit; and a processing unit, electrically connected to the infrared sensing element and the adjustment unit. When the adjustment unit is located on the second position, the adjustment unit is configured to confine a field of view defined by the infrared sensing element, the first lens, and the adjustment unit.

### CROSS-REFERENCE TO RELATED APPLICATION

This application claims benefit of priority to Taiwanese Patent Application No. 114110244 filed Mar. 19, 2025, the entire contents of which are incorporated herein by reference.

### BACKGROUND OF THE INVENTION

### Technical Field

The technical field relates to an infrared sensing system, particularly relates to an infrared sensing system applied in detecting humans and pets.

### Description of Related Art

A general infrared sensing system includes, for example, a field of view defined by a passive infrared sensor (PIR), a Fresnel lens, and a processing unit. When a human or other object that emits strong infrared approaches the infrared sensing system, the infrared sensing system may generate an electrical signal, and the processing unit may trigger the corresponding control system according to the electrical signal. The infrared sensing system is widely used in indoor personnel sensing, anti-theft, security protection, energy saving, automatic lighting control, smart home, and other fields.

However, when a general infrared sensing system is designed to detect a human, since a human and a pet emit similar infrared, the general infrared sensing system may not detect the difference in signals between a human and a pet. As a result, a pet may be detected as a human. A pet is detected as a human, which affects applications of indoor personnel sensing, anti-theft, security protection, energy saving, automatic lighting control, smart home, and other fields.

In view of this, how to design an infrared sensing system that may detect and distinguish a human or a pet is one of the current problems that need to be solved.

### SUMMARY OF THE INVENTION

The disclosure is directed to an infrared sensing system that may detect and distinguish a human or a pet, and may also detect and distinguish an adult, a child, or a pet.

One of the exemplary embodiments is an infrared sensing system, including: an infrared sensing element; an adjustment unit, disposed movably between a first position and a second position; a first lens, disposed between the infrared sensing element and the adjustment unit; and a processing unit, electrically connected to the infrared sensing element and the adjustment unit; wherein, when the adjustment unit is located on the second position, the adjustment unit is configured to confine a field of view defined by the infrared sensing element, the first lens, and the adjustment unit.

In some embodiments, the adjustment unit is a light shielding element or a second lens.

In some embodiments, when the adjustment unit is located on the first position, a first detection angle is defined by the infrared sensing element, the first lens and the adjustment unit; when the adjustment unit is located on the second position, a second detection angle is defined by the infrared sensing element, the first lens and the adjustment unit; the second detection angle is less than the first detection angle.

In some embodiments, when the adjustment unit is located on the first position, the adjustment unit is located outside the first detection angle; when the adjustment unit is located on the second position, part of or all of the adjustment unit is located inside the first detection angle.

In some embodiments, the first detection angle is substantially equal to 21.8 degrees, and the second detection angle is substantially equal to 16.7 degrees.

In some embodiments, a height of the infrared sensing element distanced from a ground is substantially equal to 2 meters.

In some embodiments, the adjustment unit is configured to move from the second position to a third position, when the adjustment unit is located on the third position, a third detection angle is defined by the infrared sensing element, the first lens, and the adjustment unit; the third detection angle is less than the second detection angle.

In some embodiments, when the adjustment unit is located on the first position, a first detection distance is defined by the infrared sensing element, the first lens and the adjustment unit; when the adjustment unit is located on the second position, a second detection distance is defined by the infrared sensing element, the first lens and the adjustment unit; the second detection distance is larger than the first detection distance.

In some embodiments, when the adjustment unit is located on the second position, part of or all of the adjustment unit is located inside a first detection angle defined by the infrared sensing element and the first lens.

In some embodiments, the infrared sensing element is a pyroelectric infrared sensing element.

In some embodiments, the first lens and the second lens are respectively a Fresnel lens.

In summary, the infrared sensing system of this embodiment may be disposed on a wall, a tripod, or a ceiling. The processing unit of the infrared sensing system may control the infrared sensing element to turn on and control the adjustment unit to the first position. When a human or a pet enters the first field of view (for example, the first detection angle or the first detection distance) of the infrared sensing system, the infrared sensing element generates an electrical signal. The processing unit receives the electrical signal and controls the adjustment unit to the second position. As a result, the field of view of the infrared sensing system is reduced from the first field of view to the second field of view (for example, the second detection angle or the second detection distance). If the infrared sensing element is still generating electrical signals, the processing unit determines that a human is in front of the infrared sensing element; if the infrared sensing element stops generating electrical signals, the processing unit determines that a pet is in front of the infrared sensing element. The infrared sensing system is beneficial to applications of indoor personnel sensing, anti-theft, security protection, energy saving, automatic lighting control, smart home, and other fields.

Similarly, the adjustment unit of the infrared sensing system of the present disclosure may also be located on the third position to make the field of view of the infrared sensing system be reduced from the second field of view to the third field of view (for example, the third detection angle or third detection distance) to detect an adult, a child and a pet.

Moreover, the adjustment unit is the light shielding element, which may achieve cost savings. The adjustment unit is the second lens, which may increase different configurations.

Further, the height of the infrared sensing element of the infrared sensing system is equal to 2 meters above the ground. The first detection angle is equal to 21.8 degrees, and the second detection angle is equal to 16.7 degrees. As a result, the infrared sensing system is suitable for installation in indoor spaces to detect a human, a medium-sized dog, or other pets.

### BRIEF DESCRIPTION OF THE DRAWINGS

FIG. 1 is a schematic diagram of the adjustment unit of the infrared sensing system located on the first position in accordance with a first embodiment of the present disclosure.

FIG. 2A is a schematic diagram of the adjustment unit of the infrared sensing system located on the first position in accordance with a second embodiment of the present disclosure.

FIG. 2B is a schematic diagram of the adjustment unit of the infrared sensing system located on the second position in accordance with a second embodiment of the present disclosure.

FIG. 2C is a schematic diagram of the adjustment unit of the infrared sensing system located on the third position in accordance with a second embodiment of the present disclosure.

FIG. 3A is a schematic diagram of the adjustment unit of the infrared sensing system located on the first position in accordance with a third embodiment of the present disclosure.

FIG. 3B is a schematic diagram of the adjustment unit of the infrared sensing system located on the second position in accordance with a third embodiment of the present disclosure.

FIG. 4A is a schematic diagram of the adjustment unit of the infrared sensing system located on the first position in accordance with a fourth embodiment of the present disclosure.

FIG. 4B is a schematic diagram of the adjustment unit of the infrared sensing system located on the second position in accordance with a fourth embodiment of the present disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

As used in the present disclosure, terms such as “first”, “second”, and “third” are employed to describe various elements, components, regions, layers, and/or parts. These terms should not be construed as limitations on the mentioned elements, components, regions, layers, and/or parts. Instead, they are used merely for distinguishing one element, component, region, layer, or part from another. Unless explicitly indicated in the context, the usage of terms such as “first”, “second” and “third” does not imply any specific sequence or order.

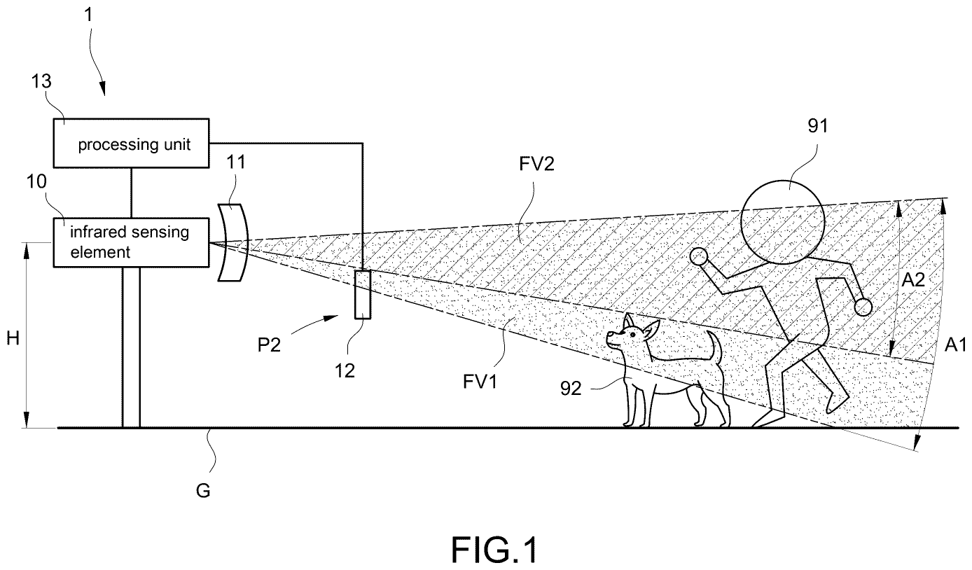

FIG. 1 is a schematic diagram of the adjustment unit of the infrared sensing system located on the first position in accordance with a first embodiment of the present disclosure. Please refer to FIG. 1, the infrared sensing system 1 of this embodiment includes an infrared sensing element 10, a first lens 11, an adjustment unit 12, and a processing unit 13.

The infrared sensing element 10 may detect infrared, for example, through the photoelectric effect or the pyroelectric effect. The infrared sensing element 10 for infrared detection through the photoelectric effect may be, for example, a photodiode or a photoresistor, which generates a photoelectric effect by absorbing infrared to generate a current change or voltage change. The infrared sensing element 10 for infrared detection through the pyroelectric effect may be, for example, a passive infrared sensing element (passive infrared sensor, PIR), which generates a pyroelectric effect through absorbing infrared to generate a current or voltage change. In the embodiment, the infrared sensing element 10 may be, for example, a pyroelectric infrared sensing element in the passive infrared sensing element. The pyroelectric infrared sensing element may also be called a pyroelectric infrared sensor.

The first lens 11 is disposed above the infrared sensing element 10. The first lens 11 is disposed between the infrared sensing element 10 and the adjustment unit 12. The first lens 11 may or may not contact the infrared sensing element 10, and the first lens 11 may or may not contact the adjustment unit 12. The infrared sensing element 10, the first lens 11, and the adjustment unit 12 are arranged in sequence in a specific direction, for example, from the left side to the right side in FIG. 1. The infrared sensing element 10, the first lens 11, and the adjustment unit 12 are not limited to being located on an optical axis. The first lens 11 may be, for example, a spherical lens, an aspherical lens, a Fresnel lens, or other lenses having the function of focusing or diverging infrared. Here is not intended to be limiting. The Fresnel lens may have a plurality of concentric annular regions. Each region has a specific refraction angle. As a result, the Fresnel lens has the function of focusing or diverging infrared. Compared with ordinary lenses, the Fresnel lens has the characteristics of significantly reducing thickness under the condition of a large aperture and a short focal length.

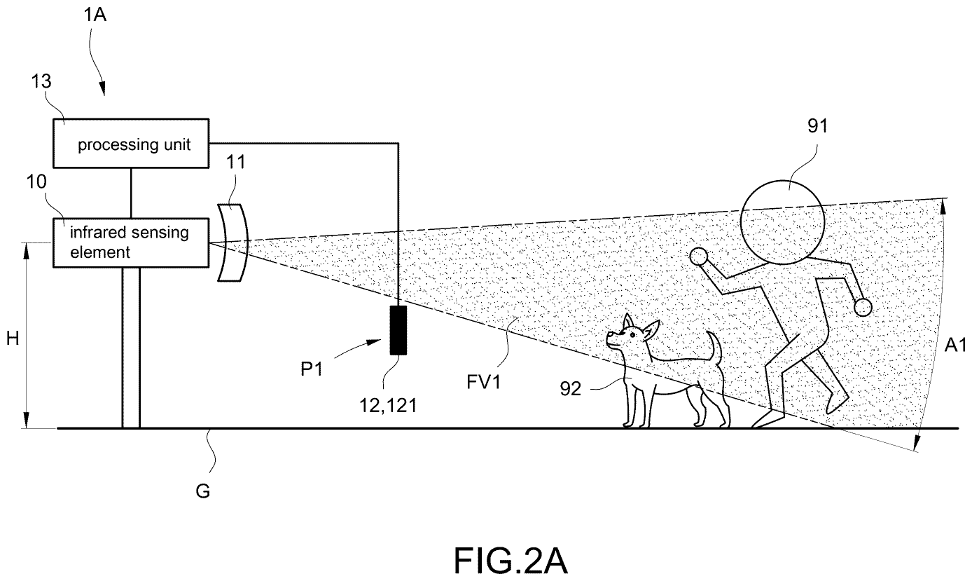

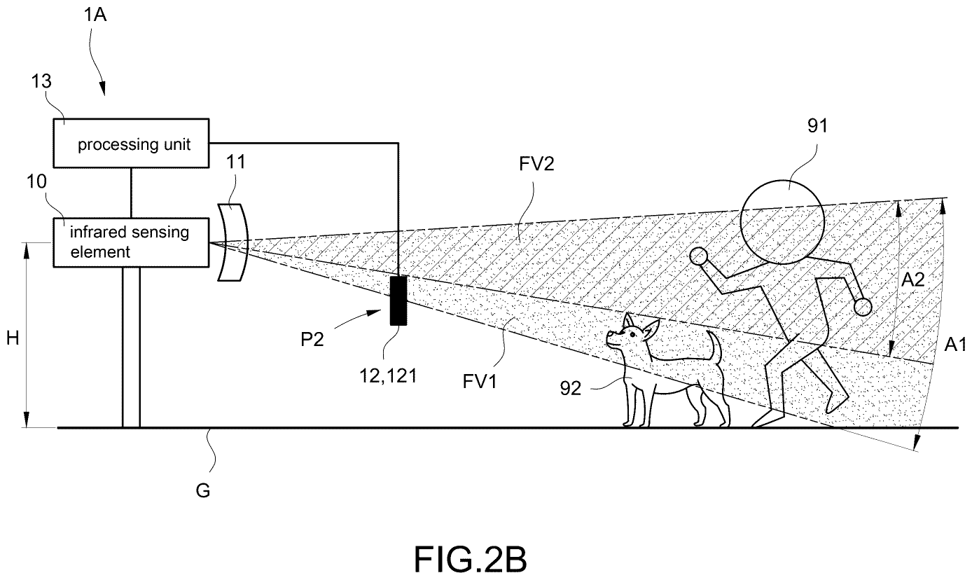

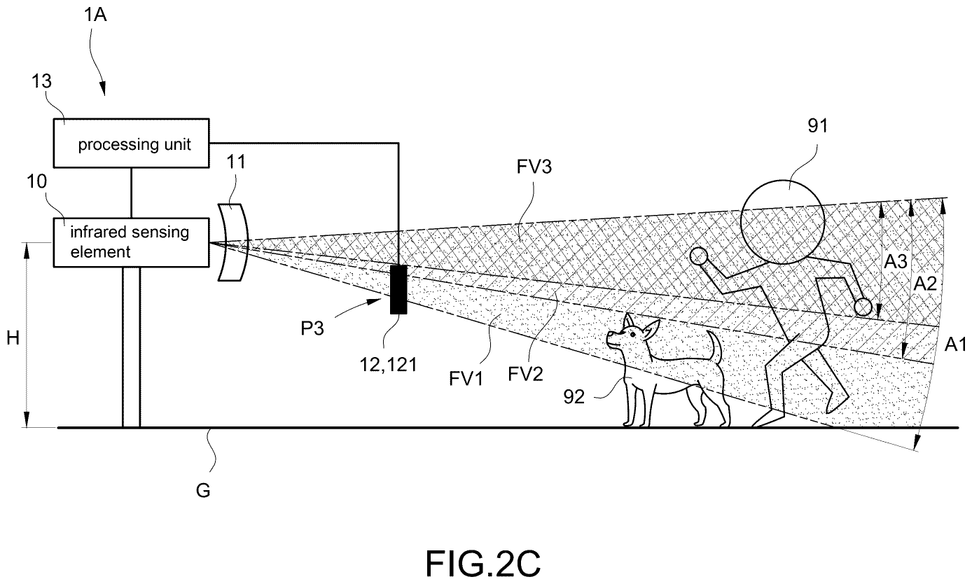

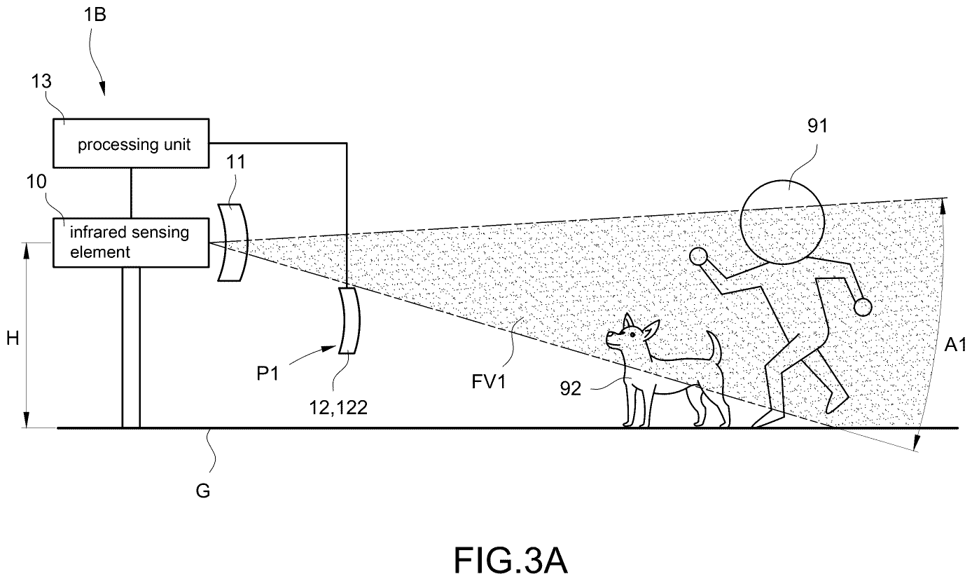

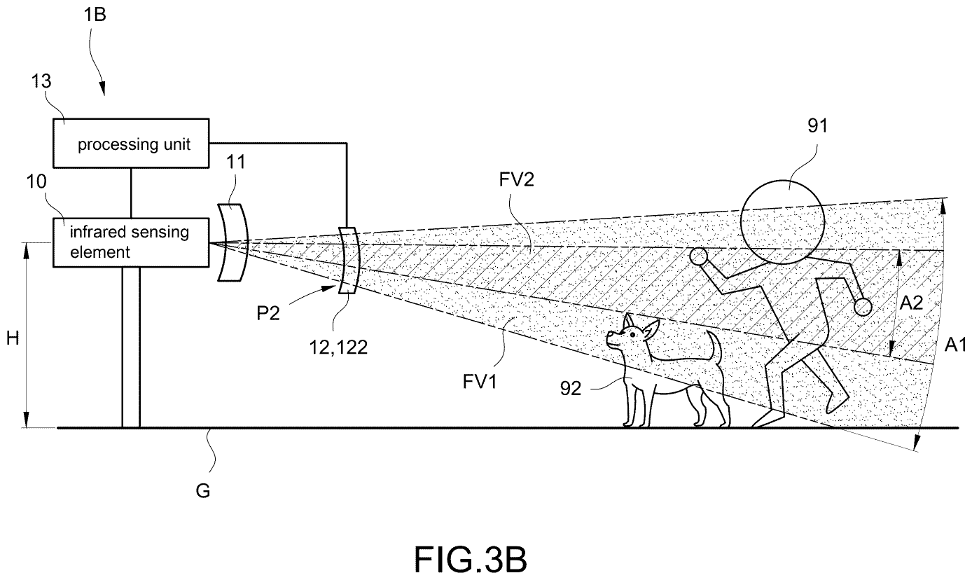

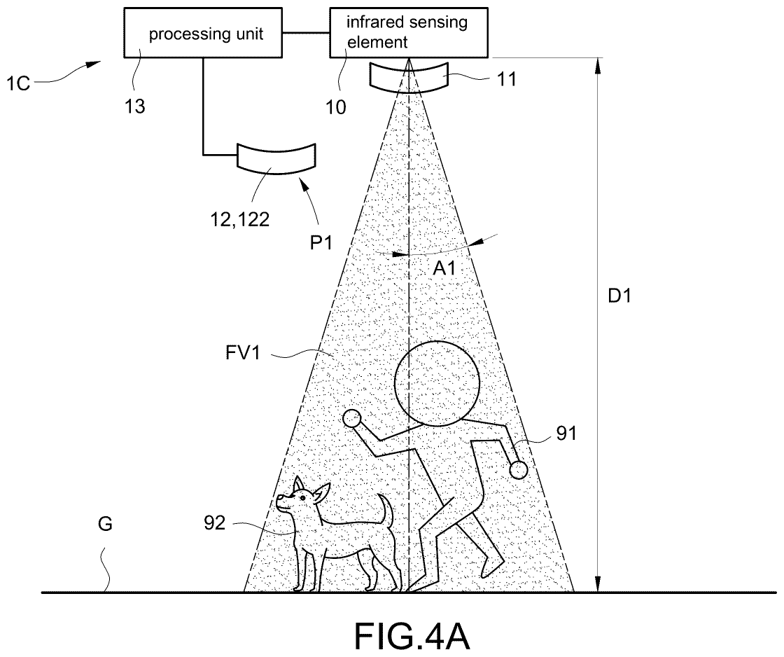

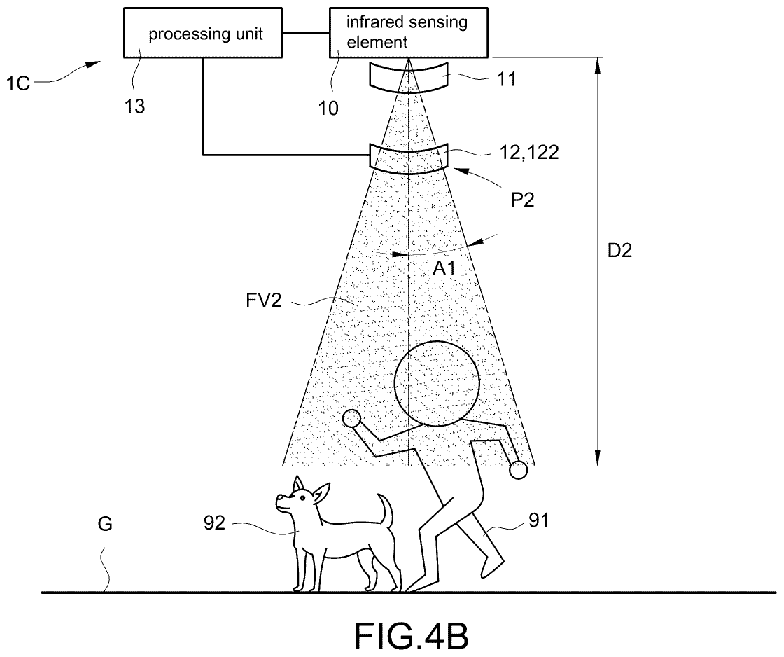

The adjustment unit 12 is disposed movably between a first position P1 (as shown in FIG. 2A, FIG. 3A, and FIG. 4A) and a second position P2 (as shown in FIG. 2B, FIG. 3B, and FIG. 4B). The adjustment unit 12 may be disposed on a bracket (not shown in the Figures), and the bracket is connected to the motor (not shown in the Figures). As a result, the adjustment unit 12 may be located between the first position P1 and the second position P2. Here is not intended to be limiting. When the adjustment unit 12 is located on the first position P1, a first field of view FV1 (the dot matrix area in FIG. 1) may be defined by the infrared sensing element 10, the first lens 11, and the adjustment unit 12. The field of view is the spatial range of infrared that may be detected through the infrared sensing system 1. The spatial range is, for example, a cone or a quadrangular pyramid. When the adjustment unit 12 is located on the second position P2, the adjustment unit 12 is configured to confine a field of view defined by the infrared sensing element 10, the first lens 11, and the adjustment unit 12. As a result, the field of view of the infrared sensing system 1 is reduced from the first field of view FV1 to a second field of view FV2 (the area marked with diagonal lines in FIG. 1). The adjustment unit 12 may confine the field of view through confining the horizontal detection angle, vertical detection angle, detection distance, or detection space shape. The adjustment unit 12 may be, for example, a light shielding element 121 (as shown in FIG. 2A) or a second lens 122 (as shown in FIG. 3A) etc. to confine the field of view defined by the infrared sensing element 10, the first lens 11, and the adjustment unit 12.

The processing unit 13 is electrically connected to the infrared sensing element 10 and the adjustment unit 12. The processing unit 13 may, for example, receive the electrical signal generated through the infrared sensing element 10, control the opening and closing of the infrared sensing element 10, and control the position of the adjustment unit 12. The processing unit 13 may include, for example, a digital signal processor (DSP), a programmable logic controller (PLC), a central process unit (CPU), a micro control unit (MCU), a field programmable gate array (FPGA) or a system on chip (SoC) etc.

In summary, the infrared sensing system 1 of this embodiment may be disposed on a wall or a tripod. The processing unit 13 of the infrared sensing system 1 may control the infrared sensing element 10 to turn on and control the adjustment unit 12 to the first position P1. When a human 91 or a pet 92 enters the first field of view FV1 of the infrared sensing system 1, the infrared sensing element 10 generates an electrical signal. The processing unit 13 receives the electrical signal and controls the adjustment unit 12 to the second position P2. As a result, the field of view of the infrared sensing system 1 is reduced from the first field of view FV1 to the second field of view FV2. If the infrared sensing element 10 is still generating electrical signals, the processing unit 13 determines that a human 91 is in front of the infrared sensing element 10; if the infrared sensing element 10 stops generating electrical signals, the processing unit 13 determines that a pet 92 is in front of the infrared sensing element 10. As a result, the infrared sensing system 1 of the present disclosure may detect and distinguish a human 91 or a pet 92. The infrared sensing system 1 is beneficial to applications of indoor personnel sensing, anti-theft, security protection, energy saving, automatic lighting control, smart home, and other fields.

FIG. 2A is a schematic diagram of the adjustment unit of the infrared sensing system located on the first position in accordance with a second embodiment of the present disclosure. FIG. 2B is a schematic diagram of the adjustment unit of the infrared sensing system located on the second position in accordance with a second embodiment of the present disclosure. FIG. 2C is a schematic diagram of the adjustment unit of the infrared sensing system located on the third position in accordance with a second embodiment of the present disclosure. Please refer to FIG. 2A, FIG. 2B, and FIG. 2C. In this embodiment, the infrared sensing system 1A includes an infrared sensing element 10, a first lens 11, a light shielding element 121, and a processing unit 13.

The infrared sensing element 10, the first lens 11, and the processing unit 13 of this embodiment are similar to those of the first embodiment. Here is omitted for brevity. The difference between the second embodiment and the first embodiment is that the adjustment unit 12 of the second embodiment is the light shielding element 121.

The light shielding element 121 may be disposed on a bracket (not shown in the Figures), and the bracket is connected to the motor (not shown in the Figures). As a result, the light shielding element 121 may be located between the first position P1 and the second position P2. Here is not intended to be limiting. The light shielding element 121 has extremely low penetration in the infrared band and may shield infrared. The material of the light shielding element 121 may be, for example, metal or an infrared cutoff filter. Here is not intended to be limiting. When the light shielding element 121 is located on the first position P1, a first field of view FV1 may be defined by the infrared sensing element 10, the first lens 11, and the light shielding element 121. The first field of view FV1 includes a first detection angle A1. When the light shielding element 121 is located on the second position P2, the light shielding element 121 shields the field of view defined by the infrared sensing element 10, the first lens 11, and the light shielding element 121. As a result, the field of view of the infrared sensing system 1A is reduced from the first field of view FV1 to the second field of view FV2. The second field of view FV2 includes a second detection angle A2. The second detection angle A2 is less than the first detection angle A1. The first detection angle A1 may be, for example, equal to 21.8 degrees. The second detection angle A2 may be, for example, equal to 16.7 degrees. A height H of the infrared sensing element 10 distanced from a ground G may be, for example, equal to 2 meters. The infrared sensing element 10 may be, for example, disposed on a wall or a tripod to make the vertical distance between the infrared sensing element 10 and the ground G be equal to 2 meters.

In some embodiments, the adjustment unit 12 may further be configured to move from the second position P2 to a third position P3. When the adjustment unit 12 is located on the third position P3, a third detection angle A3 is defined by the infrared sensing element 10, the first lens 11, and the adjustment unit 12. The third detection angle A3 is less than the second detection angle A2. In other words, the adjustment unit 12 may be moved to the first position P1, the second position P2, or the third position P3 to make the corresponding field of view of the infrared sensing system 1A be the first field of view FV1, the second field of view FV2, and a third field of view FV3, and make the corresponding detection angle of the infrared sensing system 1A be the first detection angle A1, the second detection angle A2 and, the third detection angle A3.

In some embodiments, when the light shielding element 121 is located on the first position P1, the light shielding element 121 is located outside the first detection angle A1; when the light shielding element 121 is located on the second position P2, part of or all of the light shielding element 121 is located inside the first detection angle A1. For example, when the light shielding element 121 is located on the first position P1, the light shielding element 121 may not shield the first field of view FV1 of the infrared sensing system 1A; when the light shielding element 121 is located on the second position P2, part of or all of the light shielding element 121 may shield the first field of view FV1 of the infrared sensing system 1A, and the second field of view FV2 is defined.

In summary, the infrared sensing system 1A of this embodiment has the functions of the first embodiment. Moreover, the adjustment unit 12 is the light shielding element 121, which may achieve cost savings and increase the different configurations. Further, the height H of the infrared sensing element 10 of the infrared sensing system 1A is equal to 2 meters above the ground G. The first detection angle A1 is equal to 21.8 degrees, and the second detection angle A2 is equal to 16.7 degrees. As a result, the infrared sensing system 1A is suitable for installation in indoor spaces to detect a human 91, a medium-sized dog, or other pets 92. Besides, the infrared sensing system 1A of the present disclosure may define the first detection angle A1, the second detection angle A2, and the third detection angle A3 to detect and distinguish, for example, an adult, a child, or a pet 92. The infrared sensing system 1A is beneficial to applications of indoor personnel sensing, anti-theft, security protection, energy saving, automatic lighting control, smart home, and other fields.

FIG. 3A is a schematic diagram of the adjustment unit of the infrared sensing system located on the first position in accordance with a third embodiment of the present disclosure. FIG. 3B is a schematic diagram of the adjustment unit of the infrared sensing system located on the second position in accordance with a third embodiment of the present disclosure. Please refer to FIG. 3A and FIG. 3B, the infrared sensing system 1B of this embodiment includes an infrared sensing element 10, a first lens 11, a second lens 122, and a processing unit 13.

The infrared sensing element 10, the first lens 11, and the processing unit 13 of this embodiment are similar to those of the first embodiment. Here is omitted for brevity. The difference between the third embodiment and the first embodiment is that the adjustment unit 12 of the third embodiment is the second lens 122.

The second lens 122 may be disposed on a bracket (not shown in the Figures), and the bracket is connected to the motor (not shown in the Figures). As a result, the second lens 122 may be located between the first position P1 and the second position P2. Here is not intended to be limiting. When the second lens 122 is located on the first position P1, a first field of view FV1 may be defined by the infrared sensing element 10, the first lens 11, and the second lens 122. The first field of view FV1 has the first detection angle A1. When the second lens 122 is located on the second position P2, the second lens 122 refracts the infrared to confine a field of view defined by the infrared sensing element 10, the first lens 11, and the second lens 122. As a result, the field of view of the infrared sensing system 1B is reduced from the first field of view FV1 to the second field of view FV2. The second field of view FV2 has the second detection angle A2. The second detection angle A2 is less than the first detection angle A1. The upper edge of the second detection angle A2 may, for example, be aligned or not aligned with the upper edge of the first detection angle A1 (as shown in FIG. 3B). The second lens 122 may be, for example, a spherical lens, an aspherical lens, a Fresnel lens, or other lenses having the function of focusing or diverging infrared. Here is not intended to be limiting.

As a result, the infrared sensing system 1B of this embodiment has the functions of the first embodiment. Moreover, the adjustment unit 12 is the second lens 122, which may increase different configurations. The infrared sensing system 1B is beneficial to applications of indoor personnel sensing, anti-theft, security protection, energy saving, automatic lighting control, smart home, and other fields.

FIG. 4A is a schematic diagram of the adjustment unit of the infrared sensing system located on the first position in accordance with a fourth embodiment of the present disclosure. FIG. 4B is a schematic diagram of the adjustment unit of the infrared sensing system located on the second position in accordance with a fourth embodiment of the present disclosure. Please refer to FIG. 4A and FIG. 4B, the infrared sensing system 1C of this embodiment includes an infrared sensing element 10, a first lens 11, a second lens 122 a processing unit 13.

The difference between the fourth embodiment and the third embodiment is that the second lens 122 of the third embodiment is moved to the first position P1 or the second position P2 to adjust the detection angle of the infrared sensing system 1B (as shown in FIG. 3A and FIG. 3B) , but the second lens 122 of the fourth embodiment is moved to the first position P1 or the second position P2 to adjust the detection distance of the infrared sensing system 1C.

When the second lens 122 is located on the first position P1, a first detection distance D1 is defined by the infrared sensing element 10, the first lens 11 and the second lens 122; when the second lens 122 is located on the second position P2, a second detection distance D2 is defined by the infrared sensing element 10, the first lens 11 and the second lens 122. For example, the second position P2 of the second lens 122 is located on an optical axis of the infrared sensing system 1C. When the second lens 122 is located on the first position P1, the first lens 11 makes the detection distance of the infrared sensing system 1C be the first detection distance D1, and the second lens 122 may not affect an optical path of the infrared sensing system 1C. When the second lens 122 is located on the second position P2, an equivalent focal length is defined by the first lens 11 and the second lens 122, to make the detection distance of the infrared sensing system 1C be the second detection distance D2. The second detection distance D2 may be, for example, larger than the first detection distance D1.

In some embodiments, when the second lens 122 is located on the second position P2, part of or all of the second lens 122 is located inside the first detection angle A1 defined by the infrared sensing element 10, the first lens 11, and the second lens 122. In other words, when the second lens 122 is located on the second position P2, infrared may be refracted to the first lens 11 and enter the infrared sensing element 10. As a result, the effect of adjusting the focal length may be achieved.

In summary, the infrared sensing system 1C of this embodiment may be disposed on the ceiling. The processing unit 13 of the infrared sensing system 1C may control the infrared sensing element 10 to turn on and control the second lens 122 to the first position P1. When a human 91 or a pet 92 enters the first detection distance D1 of the infrared sensing system 1C, the infrared sensing element 10 may generate an electrical signal. The processing unit 13 receives the electrical signal and controls the second lens 122 to the second position P2. As a result, the detection distance of the infrared sensing system 1 is changed from the first detection distance D1 to the second detection distance D2. If the infrared sensing element 10 is still generating electrical signals, the processing unit 13 determines that a human 91 is in front of the infrared sensing element 10; if the infrared sensing element 10 stops generating electrical signals, the processing unit 13 determines that a pet 92 is in front of the infrared sensing element 10. As a result, the infrared sensing system 1C of the present disclosure may detect and distinguish a human 91 or a pet 92. The infrared sensing system 1C is beneficial to applications of indoor personnel sensing, anti-theft, security protection, energy saving, automatic lighting control, smart home, and other fields.

In summary, the infrared sensing system of this embodiment may be disposed on a wall, a tripod, or a ceiling. The processing unit of the infrared sensing system may control the infrared sensing element to turn on and control the adjustment unit to the first position. When a human or a pet enters the first field of view (for example, the first detection angle or the first detection distance) of the infrared sensing system, the infrared sensing element generates an electrical signal. The processing unit receives the electrical signal and controls the adjustment unit to the second position. As a result, the field of view of the infrared sensing system is reduced from the first field of view to the second field of view (for example, the second detection angle or the second detection distance). If the infrared sensing element is still generating electrical signals, the processing unit determines that a human is in front of the infrared sensing element; if the infrared sensing element stops generating electrical signals, the processing unit determines that a pet is in front of the infrared sensing element. The infrared sensing system is beneficial to applications of indoor personnel sensing, anti-theft, security protection, energy saving, automatic lighting control, smart home, and other fields.

Similarly, the adjustment unit of the infrared sensing system of the present disclosure may also be located on the third position to make the field of view of the infrared sensing system be reduced from the second field of view to the third field of view (for example, the third detection angle or third detection distance) to detect an adult, a child and a pet.

Moreover, the adjustment unit is the light shielding element, which may achieve cost savings. The adjustment unit is the second lens, which may increase different configurations.

Further, the height of the infrared sensing element of the infrared sensing system is equal to 2 meters above the ground. The first detection angle is equal to 21.8 degrees, and the second detection angle is equal to 16.7 degrees. As a result, the infrared sensing system is suitable for installation in indoor spaces to detect a human, a medium-sized dog, or other pets.

As used herein and not otherwise defined, the terms “substantially” and “approximately” are used to describe and account for small variations. When used in conjunction with an event or circumstance, the terms may refer to instances in which the event or circumstance occurs precisely as well as instances in which the event or circumstance occurs to a close approximation. For example, when used in conjunction with a numerical value, the terms may refer to a range of variation of less than or equal to the numerical value.

While this disclosure has been described by means of specific embodiments, numerous modifications and variations may be made thereto by those skilled in the art without departing from the scope and spirit of this disclosure set forth in the claims.

What is claimed is:

1. An infrared sensing system, comprising:
an infrared sensing element;
an adjustment unit, disposed movably between a first position and a second position;
a first lens, disposed between the infrared sensing element and the adjustment unit; and
a processing unit, electrically connected to the infrared sensing element and the adjustment unit;
wherein, when the adjustment unit is located on the second position, the adjustment unit is configured to confine a field of view defined by the infrared sensing element, the first lens, and the adjustment unit.

2. The infrared sensing system of claim 1, wherein the adjustment unit is a light shielding element or a second lens.

3. The infrared sensing system of claim 1, wherein when the adjustment unit is located on the first position, a first detection angle is defined by the infrared sensing element, the first lens and the adjustment unit; when the adjustment unit is located on the second position, a second detection angle is defined by the infrared sensing element, the first lens and the adjustment unit; the second detection angle is less than the first detection angle.

4. The infrared sensing system of claim 3, wherein when the adjustment unit is located on the first position, the adjustment unit is located outside the first detection angle; when the adjustment unit is located on the second position, part of or all of the adjustment unit is located inside the first detection angle.

5. The infrared sensing system of claim 4, wherein the first detection angle is substantially equal to 21.8 degrees, and the second detection angle is substantially equal to 16.7 degrees.

6. The infrared sensing system of claim 5, wherein a height of the infrared sensing element distanced from a ground is substantially equal to 2 meters.

7. The infrared sensing system of claim 3, wherein the adjustment unit is configured to move from the second position to a third position, when the adjustment unit is located on the third position, a third detection angle is defined by the infrared sensing element, the first lens, and the adjustment unit; the third detection angle is less than the second detection angle.

8. The infrared sensing system of claim 1, wherein when the adjustment unit is located on the first position, a first detection distance is defined by the infrared sensing element, the first lens and the adjustment unit; when the adjustment unit is located on the second position, a second detection distance is defined by the infrared sensing element, the first lens and the adjustment unit; the second detection distance is larger than the first detection distance.

9. The infrared sensing system of claim 8, wherein when the adjustment unit is located on the second position, part of or all of the adjustment unit is located inside a first detection angle defined by the infrared sensing element and the first lens.

10. The infrared sensing system of claim 1, wherein the infrared sensing element is a pyroelectric infrared sensing element.

11. The infrared sensing system of claim 2, wherein the first lens and the second lens are respectively a Fresnel lens.
